(19) United States
(12) Patent Application Publication
(10) Pub. No.: US 2009/0304836 A1
(43) Pub. Date: Dec. 10, 2009

(54) Powder compression molding machine

(75) Inventors: Yoshitsugu Oneda, Kyoto (JP); Hiroyuki Kato, Kyoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Kikusui Seisakusho Ltd., Kyoto-shi (JP)

(21) Appl. No.: 12/453,819

(22) Filed: May 22, 2009

(30) Foreign Application Priority Data
Jun. 10, 2008 (JP) P2008-151893
Feb. 27, 2009 (JP) P2009-046289

(51) Int. Cl. B28B 13/02

(52) U.S. Cl. 425/98

(57) ABSTRACT

This invention provides a powder compression molding machine including: upper punches and lower punches disposed to face with each other along one central axis; die holes allowing tips of the upper punches and the lower punches to be respectively inserted thereinto, the upper punches and the lower punches being shifted to approach each other with the tips thereof being inserted in the corresponding die holes, so that a powder material filled in the die holes is compressed and molded; and powder lubricant spraying means for spraying a powder lubricant toward the die holes before the powder material is filled therein, wherein the powder lubricant spraying means includes: a downward spray nozzle that sprays the powder lubricant toward the die holes; a powder lubricant retrieving mechanism that retrieves a superfluous powder lubricant out of the powder lubricant sprayed from the powder lubricant spraying means; a charging device that electrostatically charges the powder lubricant sprayed from the downward spray nozzle; and switching means that is connected to the charging device and switches to allow only the powder lubricant sprayed at a timing of reaching each of the die holes to be electrostatically charged.

### BACKGROUND OF THE INVENTION

1. Field of the Invention

The present invention relates to a powder compression molding machine that compresses a powder material to mold a tablet, an electronic component, or the like.

2. Description of the Related Art

In conventional production of a medical tablet using a rotary powder compression molding machine, there is sometimes caused a trouble of so-called sticking in which a powder material for the tablet including only medical formula ingredients, or the produced tablet sticks onto a punch or a die. In order to prevent such a trouble, there has been invented a method of spraying a powder lubricant such as magnesium stearate or talc onto an upper punch, a lower punch, and a die hole prior to tableting, so that the powder lubricant adheres to regions such as surfaces of the punches and the die hole, where sticking will occur. There has been invented another method of compressing only a powder lubricant to produce a dummy tablet prior to tableting so that an upper punch, a lower punch, and a die hole are coated with the powder lubricant. There has been further invented provision of powder lubricant spraying means that includes a spray nozzle, an airflow supplying mechanism, and a charging device. The spray nozzle has a concave surface facing an end surface of a punch at a position to be sprayed with a powder lubricant so as to spray the powder lubricant while being guided along the concave surface substantially toward the end surface of the punch. The airflow supplying mechanism blows air toward the vicinity of a lower end surface of an upper punch so as to inhibit upward scattering of the powder lubricant sprayed from the spray nozzle. The charging device electrostatically charges the powder lubricant sprayed from the spray nozzle and also electrostatically charges at least the upper punch, a lower punch, and a die so as to have reverse polarity to the electrostatically charged powder lubricant. In such a configuration, the powder lubricant electrostatically adheres substantially evenly to the end surfaces of the upper and lower punches as well as to an inner peripheral surface of a die hole. Accordingly, the powder lubricant is allowed to adhere more efficiently (refer to International Publication No. WO 2003/051621 Pamphlet, or the like).

In the configuration described in International Publication No. WO 2003/051621 Pamphlet, the electrostatically charged powder lubricant is sprayed continuously toward the die holes, which adheres also to regions between the adjacent die holes and is mixed into the powder material at a feed shoe. Accordingly, there occurs troublesome contamination.

### SUMMARY OF THE INVENTION

The present invention provides a configuration that solves such a problem described above.

Specifically, the present invention provides a powder compression molding machine including: upper punches and lower punches disposed to face with each other along one central axis; die holes allowing tips of the upper punches and the lower punches to be respectively inserted thereinto, the upper punches and the lower punches being shifted to approach each other with the tips thereof being inserted in the corresponding die holes, so that a powder material filled in the die holes is compressed and molded; and powder lubricant spraying means for spraying a powder lubricant toward the die holes before the powder material is filled therein, wherein the powder lubricant spraying means includes: a downward spray nozzle that sprays the powder lubricant toward the die holes; a powder lubricant retrieving mechanism that retrieves a superfluous powder lubricant out of the powder lubricant sprayed from the powder lubricant spraying means; a charging device that electrostatically charges the powder lubricant sprayed from the downward spray nozzle; and switching means that is connected to the charging device and switches to allow only the powder lubricant sprayed at a timing of reaching each of the die holes to be electrostatically charged.

In this configuration, the powder lubricant reaching the die holes is electrostatically charged, which adheres to the die holes against a dust pickup airflow provided by the powder lubricant retrieving mechanism. On the other hand, the powder lubricant reaching other regions is electrostatically uncharged, which is directed to a dust pickup conduit due to the dust pickup airflow provided by the powder lubricant retrieving mechanism and is retrieved into a dust pickup device. While the powder lubricant securely adheres to the die holes, there remains no powder lubricant at regions between the adjacent die holes, thereby resulting in suppressed contamination.

In order to easily realize the above switching means, there is exemplified the switching means having: a pulse generating mechanism that generates pulses at an interval from one of the die holes being located right below the downward spray nozzle to the following adjacent die hole being located therebelow; and a switch body that distributes power to the charging device only while each of the pulses is outputted from the pulse generating mechanism.

The powder lubricant spraying means further includes: an upward spray nozzle that sprays the powder lubricant toward lower ends of the upper punches; an airflow supplying mechanism that blows air toward the powder lubricant retrieving mechanism so as to inhibit scattering of the powder lubricant sprayed from the upward spray nozzle; a second charging device that electrostatically charges the powder lubricant sprayed from the upward spray nozzle; and second switching means that is connected to the second charging device and switches to allow only the powder lubricant sprayed at a timing of reaching the lower end of each of the upper punches to be electrostatically charged. With this powder lubricant spraying means, similarly with regard to the powder lubricant sprayed toward the upper punches, the powder lubricant subject to adhere to the upper punches is exclusively electrostatically charged while the remaining powder lubricant is made electrostatically uncharged. Accordingly, the powder lubricant securely adheres to the upper punches while suppressing the powder lubricant from adhering to regions other than the upper punches.

### EFFECTS OF THE INVENTION

In the powder compression molding machine thus configured in accordance with the present invention, only the powder lubricant reaching the die holes is electrostatically charged, which adheres to the die holes against the dust pickup airflow provided by the powder lubricant retrieving mechanism. On the other hand, the powder lubricant not adhering to the die holes is electrostatically uncharged, which is directed to the dust pickup conduit due to the dust pickup airflow provided by the powder lubricant retrieving mechanism and is retrieved into the dust pickup device. Therefore, the powder lubricant securely adheres to the die holes while contamination being suppressed.

### BRIEF DESCRIPTION OF THE DRAWINGS

FIG. 1 is a front cross-sectional view of an entire rotary powder compression molding machine according to an embodiment of the present invention;

FIG. 2 is a schematic top plan view of a turret in the rotary powder compression molding machine according to the embodiment;

FIG. 3 is a front cross-sectional view illustrating the developed turret in the rotary powder compression molding machine according to the embodiment;

FIG. 4 is an enlarged plan view of a powder lubricant spraying portion in the rotary powder compression molding machine according to the embodiment;

FIG. 5 is a cross-sectional view cut along Line V-V illustrated in FIG. 4;

FIG. 6 is a block diagram illustrating a schematic configuration of the rotary powder compression molding machine according to the embodiment;

FIG. 7 is a block diagram illustrating a schematic configuration of a switch in the rotary powder compression molding machine according to the embodiment; and

FIG. 8 is a time flow chart illustrating a process of behaviors of the switch in the rotary powder compression molding machine according to the embodiment.

### DETAILED DESCRIPTION OF THE PREFERRED EMBODIMENTS

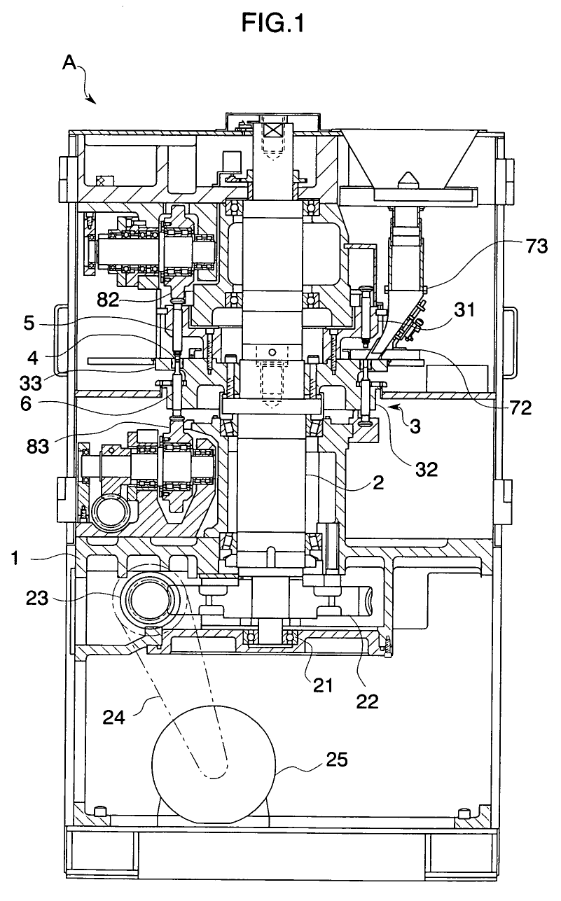

As illustrated in FIGS. 1, 2 and 3, a rotary powder compression molding machine A includes, in a frame 1, a turret 3 that is rotatable about an upright shaft 2, a plurality of dies 4 that are disposed on the turret 3 at a predetermined pitch, and upper punches 5 and lower punches 6 that are slidably retained in the vertical directions above and below the dies 4 respectively.

More specifically, the upright shaft 2 is disposed substantially at a center in the frame 1 and is supported by a bearing 21. Fixed in the vicinity of a lower end of the upright shaft 2 is a worm wheel 22, to which a rotary drive force of a motor 25 is transmitted by way of a worm 23 and a belt 24. Fixed in the vicinity of an upper end of the upright shaft 2 is the turret 3 that is divided into three different functional portions, namely, an upper punch retaining portion 31, a lower punch retaining portion 32, and a die retaining portion 33. The upper punch retaining portion 31 is provided at a top of the turret 3 and retains the upper punches 5 so as to be vertically slidable. The lower punch retaining portion 32 is provided at a bottom of the turret 3 and retains the lower punches 6 so as to be vertically slidable. The die retaining portion 33 is provided between the upper punch retaining portion 31 and the lower punch retaining portion 32 and has a plurality of die mounting holes (not illustrated) formed along a single circle to allow the dies 4 to be detachably fitted therein. The turret 3 according to the present embodiment has a flow channel (not illustrated) that is disposed in the vicinity of the dies 4 and allows a cooling medium such as water to path therethrough, so as to be cooled by the cooling medium to suppress thermal expansion of molded products. The respective dies 4 are detachably fixed in the die mounting holes via a die fixing mechanism (not illustrated) that is located on a peripheral side surface of the die retaining portion 33.

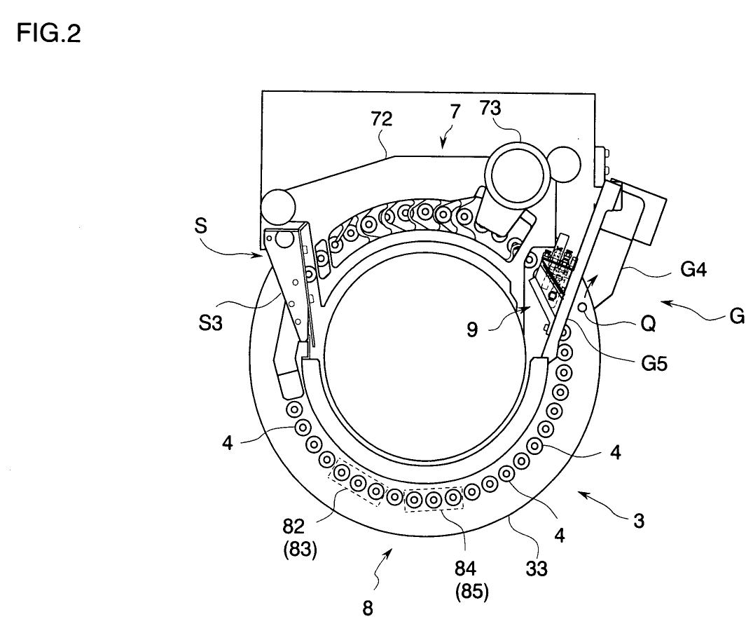

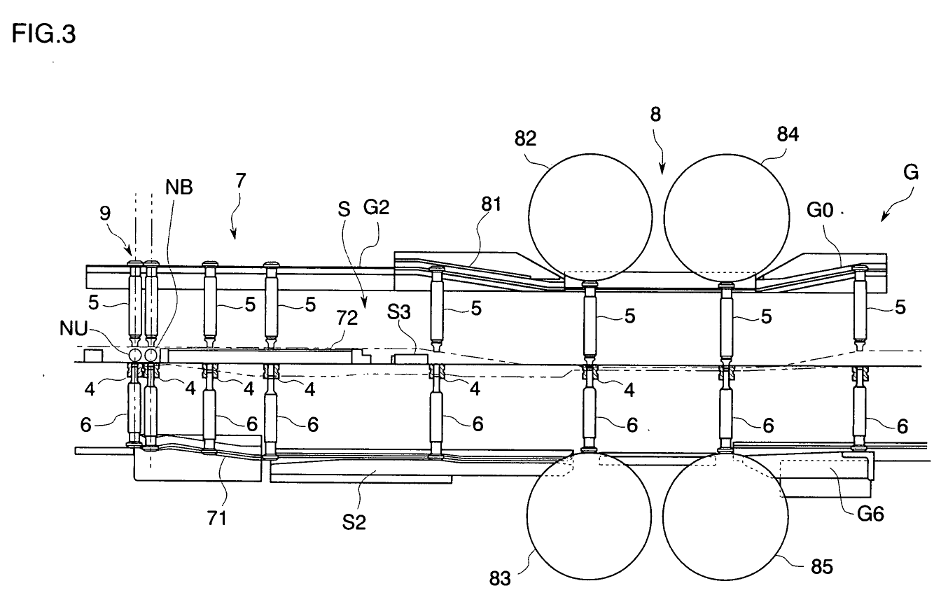

As illustrated in FIGS. 2 and 3, the rotary powder compression molding machine A is provided with a powder filling portion 7, a powder leveling portion S, a compression molding portion 8, a product unloading portion G, and a powder lubricant spraying portion 9 along a rotating direction of the turret 3 in this order.

The powder filling portion 7 has a lower punch descending device 71 that descends each of the lower punches 6, and a feed shoe 72 that fills a powder material supplied onto the turret 3 with a die hole 41 of each of the dies 4, and a powder supplying mechanism 73 that supplies the powder material onto the turret 3.

The powder leveling portion S ascends each of the lower punches 6 along a quantity adjusting rail S2 to a predetermined position and removes using a leveling plate S3 the excess powder material that overflows from the die hole 41 onto the die 4 due to the ascended lower punch 6.

The compression molding portion 8 has an upper punch descending cam 81, an upper pre-compression roll 82, a lower pre-compression roll 83, an upper main compression roll 84, and a lower main compression roll 85. The upper punch descending cam 81 descends each of the upper punches 5 along a downwardly inclined surface such that a tip of the upper punch 5 is inserted into the corresponding die hole 41. The upper pre-compression roll 82 and the lower pre-compression roll 83 restrict, from above and below respectively, the upper punch 5 and the lower punch 6 of which tips are inserted into the corresponding die hole 41, so as to preliminarily compress the powder material in the die hole 41. The upper main compression roll 84 and the lower main compression roll 85 restrict, from above and below respectively, the upper punch 5 and the lower punch 6 so as to mainly compress the powder material in the die hole 41.

As illustrated in FIGS. 2 and 3, the product unloading portion G has an upper punch ascending cam G0, a pushing up rail G6, and a guide plate G5. The upper punch ascending cam G0 ascends the upper punch 5 along an upwardly inclined surface such that the tip of the upper punch 5 is pulled out of the corresponding die hole 41. The pushing up rail G6 biases the lower punch 6 upwards to push a product Q fully out of the die hole 41. The guide plate G5 guides the pushed out product Q aside to a chute G4.

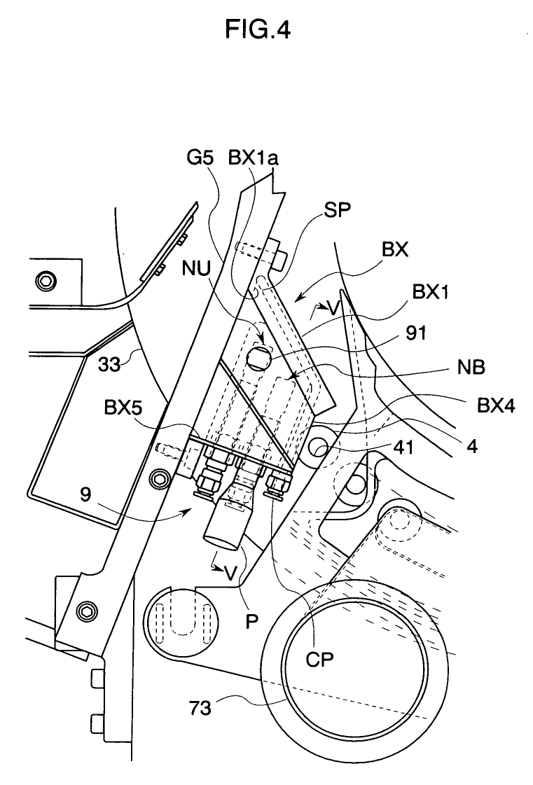

The powder lubricant spraying portion 9 is located between the product unloading portion G and the powder filling portion 7. As illustrated in FIG. 4, the powder lubricant spraying portion 9 applies, while preventing scattering, a powder lubricant L onto a lower end surface 5a of each of the upper punches 5, an upper end surface 6a of each of the lower punches 6, and an inner peripheral surface of the die hole 41 provided in each of the dies 4. The powder lubricant spraying portion 9 has a box body BX that surrounds a space to be sprayed continuously with the powder lubricant L except a penetrating hole 91 allowing the powder lubricant L to pass therethrough and to be sprayed onto the upper punches 5, and an inlet 92 for sucking therein an air curtain AC. The air curtain AC functions as an airflow and is supplied by an airflow supplying mechanism. The box body BX encloses tips of an upward spray nozzle NU that sprays the powder lubricant L toward the upper punches 5 and a downward spray nozzle NB that sprays the powder lubricant L toward the lower punches 6 and the die holes 41. The air curtain AC is blew toward the inlet 92 above the penetrating hole 91.

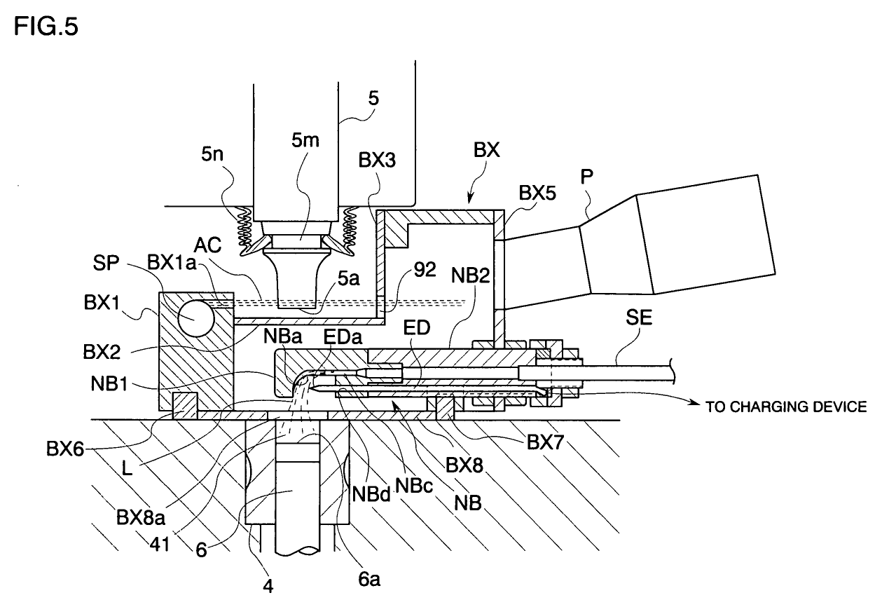

More specifically, the powder lubricant spraying portion 9 is provided with powder lubricant spraying means that applies the powder lubricant L onto the lower end surfaces 5a of the upper punches 5, the upper end surfaces 6a of the lower punches 6, and into the die holes 41 of the dies 4. As illustrated in FIGS. 4 and 5, the powder lubricant spraying means has the downward spray nozzle NB and the airflow supplying mechanism. The downward spray nozzle NB has a concave surface NBa, faces the upper end surface 6a of the lower punch 6 at a position where the powder lubricant L is applied, and sprays substantially in one direction the powder lubricant L while being guided along the concave surface NBa. The airflow supplying mechanism blows an airflow toward the vicinity of the lower end surfaces 5a of the upper punches 5 to supply the air curtain AC that inhibits upward scattering of the excess powder lubricant L sprayed from the upward spray nozzle NU. The downward spray nozzle NB is attached to the box body BX and is connected to a powder lubricant spray device LS that measures quite a small quantity of the powder lubricant L to pneumatically transport using pressurized gas. The downward spray nozzle NB is also provided with an introduction hole NBc that is communicated with the concave surface NBa. The downward spray nozzle NB is made of a fluorine resin or the like, and has a nozzle tip NB1 that is detachable from a nozzle body NB2. Though not being illustrated in the drawings, the upward spray nozzle NU included in the powder lubricant spraying means has a concave surface for guiding the powder lubricant L, similarly to that formed in the downward spray nozzle NB.

The upward spray nozzle NU and the downward spray nozzle NB are each provided with an electrode ED that is made of stainless steel or the like and electrostatically charges the powder lubricant L. More specifically, in the case of the downward spray nozzle NB, the nozzle tip NB1 and the nozzle body NB2 of the downward spray nozzle NB are provided with a penetrating hole NBd that is located in parallel with the introduction hole NBc such that the nozzle tip NB1 and the nozzle body NB2 are communicated with each other. The electrodes ED each in a round bar shape are inserted into the penetrating hole NBd. Each of the electrodes ED has a tip EDa pointed into a conical or a needle shape, and is located along an extended central axis.

The box body BX, which is made of a synthetic resin such as a fluorine resin, is fixed to a surface of the guide plate G5 facing the feed shoe 72 and is electrically insulated from the turret 3. The box body BX is configured by a first side wall BX1, a first upper wall BX2, a second upper wall BX3, a second side wall BX4, a third side wall BX5, elastic members BX6 and BX7, and a bottom plate BX8. The first side wall BX1 is provided therein with an air supplying passage SP for the air curtain AC and has an air outlet BX1a for the air curtain AC. The first upper wall BX2 is fixed horizontally from the first side wall BX1 and is provided with the penetrating hole 91 at a position corresponding to the upper punches 5. The second upper wall BX3 is disposed continuously from the first upper wall BX2 and is provided with the inlet 92 for sucking in the air curtain AC in the vicinity of a portion continuous from the first upper wall BX2. The second side wall BX4 has a guiding conduit that guides air for the air curtain AC to the air supplying passage SP and is fixed to the first side wall BX1 so as to be in parallel with the guide plate G5. The third side wall BX5 is attached perpendicularly to the second side wall BX4 in planar view. The elastic members BX6 and BX7 are electrically insulative and block gaps between the die retaining portion 33 and lower surfaces of the first side wall BX1, the upward spray nozzle NU, and the downward spray nozzle NB. The bottom plate BX8 is made of a fluorine resin or the like and is provided between the elastic members BX6 and BX7 to close the bottom portion of the box body BX.

Attached to the third side wall BX5 of the box body BX are the upward spray nozzle NU, the downward spray nozzle NB, and a dust pickup conduit P. There is attached a connector CP, which introduces air for the air curtain AC, to an end surface of the second side wall BX4 with the third side wall BX5 interposed therebetween. The bottom plate BX8 is provided at a region corresponding to a trajectory of the dies 4 with a supplying hole BX8a that has a diameter slightly larger than that of the die holes 41 and allows the powder lubricant L sprayed from the downward spray nozzle NB to pass therethrough. Provision of the bottom plate BX8 thus configured suppresses adhesion of the powder lubricant L to a minimum as the powder lubricant L adheres onto the turret 3 only at an annular portion having a width identical to that of the supplying hole BX8a, even if the turret 3 is electrostatically charged. The connector CP is connected to an air compressor (not illustrated) that generates pressurized air to form the air curtain AC, and the airflow supplying mechanism is configured by the air compressor, the supplying passage SP, and the connector CP. There is connected to the dust pickup conduit P a dust pickup device LS5, and a powder lubricant retrieving mechanism is configured by the dust pickup conduit P and the dust pickup device LS5 as well as the box body BX.

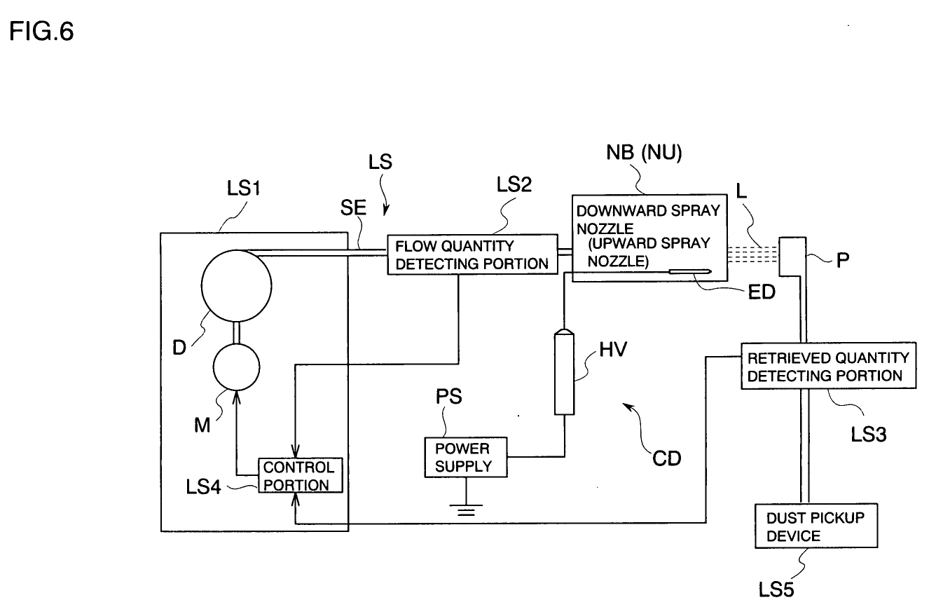

As illustrated in FIG. 6, the powder lubricant spray device LS includes a powder lubricant supplying portion LS1, a flow quantity detecting portion LS2, a retrieved quantity detecting portion LS3, a control portion LS4, the dust pickup device LS5, and a charging device CD. The powder lubricant supplying portion LS1 sends using an airflow the powder lubricant L adhering to an outer peripheral surface of a rotary drum D that is driven by a motor M. The flow quantity detecting portion LS2 detects a flow quantity of the powder lubricant L that is supplied from the powder lubricant supplying portion LS1. The retrieved quantity detecting portion LS3 detects a quantity of the powder lubricant L that is sprayed from the upward spray nozzle NU and the downward spray nozzle NB and is retrieved without adhering to none of the upper punches 5, the lower punches 6, and the die holes 41. The control portion LS4 controls the powder lubricant supplying portion LS1 in accordance with the quantities of the powder lubricant L detected by the flow quantity detecting portion LS2 and the retrieved quantity detecting portion LS3. The dust pickup device LS5 configures the powder lubricant retrieving mechanism, and the charging device CD electrostatically charges the powder lubricant L. In the present embodiment, the powder lubricant L is sprayed continuously from the upward spray nozzle NU and the downward spray nozzle NB of the powder lubricant spray device LS. The powder lubricant L sucked by the dust pickup device LS5 in the powder lubricant retrieving mechanism may be alternatively flown back to the powder lubricant supplying portion LS1.

The charging device CD includes a power supply PS, a high voltage generator HV, and the electrodes ED. The power supply PS generates an alternating voltage of about 0 to 20 V. The high voltage generator HV converts the alternating voltage supplied from the power supply PS into a direct high voltage of several tens of kV or the like and outputs the obtained direct high voltage. The electrodes ED are applied with the direct high voltage outputted from the high voltage generator HV to electrostatically charge a powder lubricant. An output terminal having a potential kept equally to a reference potential of the high voltage generator HV is grounded, and at least the upper punches 5, the lower punches 6, and the dies 4 are correspondingly grounded. In the present embodiment, the upper punches 5, the lower punches 6, and the dies 4 are grounded due to the grounded turret 3. Moreover, in the present embodiment, there are provided two charging devices CD, one including the electrode ED disposed in the downward spray nozzle NB and the other including the electrode ED disposed in the upward spray nozzle NU. The other charging device CD including the electrode ED disposed in the upward spray nozzle NU functions as a second charging device in claim 3.

Among the components of the powder lubricant spray device LS, provided outside the rotary powder compression molding machine A are the powder lubricant supplying portion LS1, the control portion LS4, the dust pickup device LS5, and the power supplies PS as well as the high voltage generators HV of the charging devices CD. On the other hand, the flow quantity detecting portion LS2, the retrieved quantity detecting portion LS3, and the electrodes ED configuring the charging devices CD are disposed inside the rotary powder compression molding machine A.

In the present embodiment, the charging devices CD are each connected to a switch SW that functions as switching means so as to electrostatically charge only the powder lubricant L sprayed from the downward spray nozzle NB at timings of reaching the die holes 41 as well as to electrostatically charge only the powder lubricant L sprayed from the upward spray nozzle NU at timings of reaching the lower ends of the upper punches 5. The switch SW connected to the charging device CD for the upward spray nozzle NU functions as second switching means in claim 3.

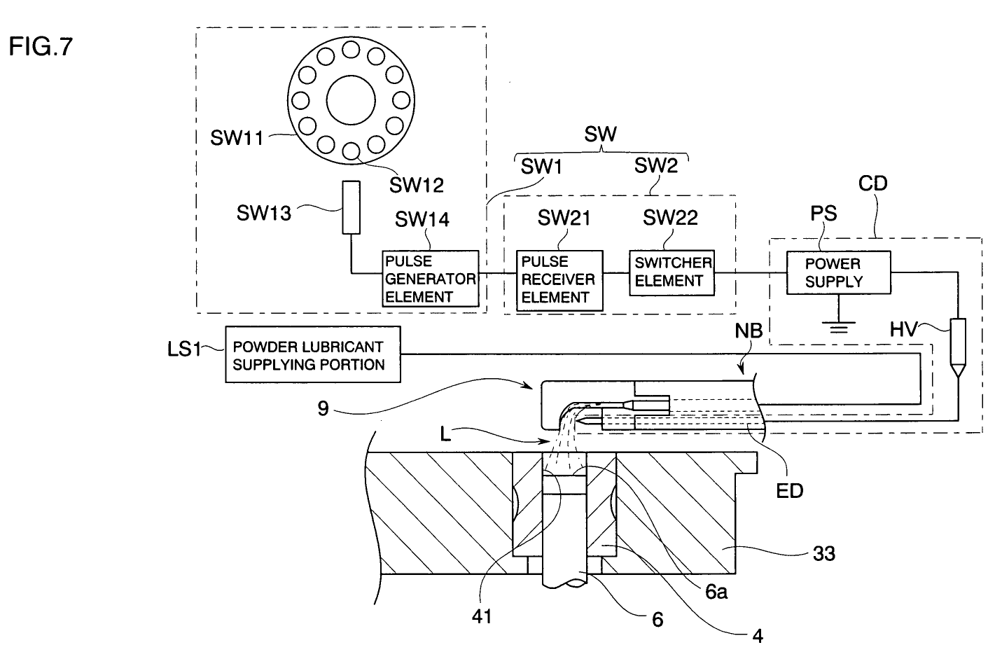

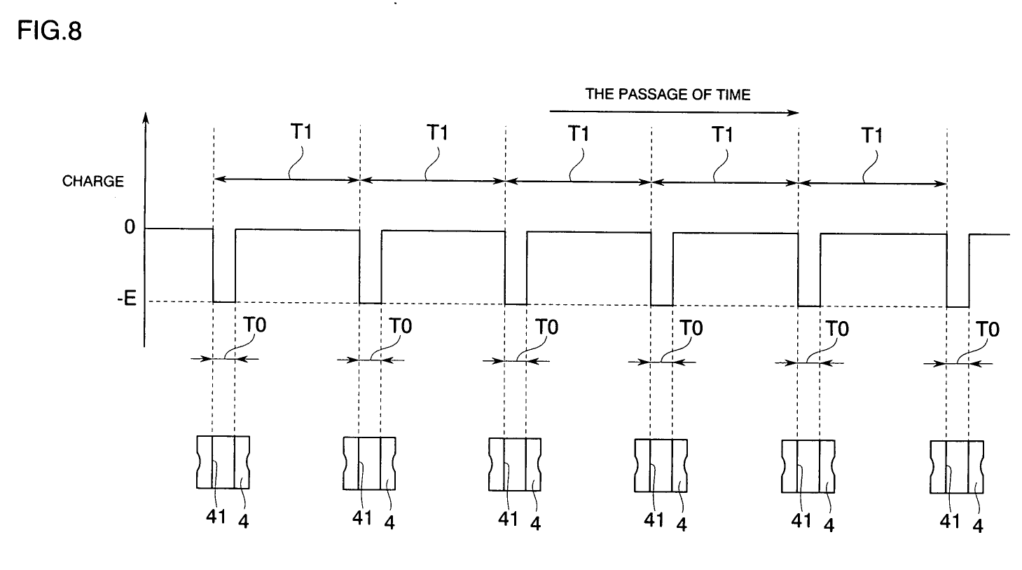

With regard to the downward spray nozzle NB, as illustrated in a block diagram of a schematic configuration in FIG. 7 and a time flow chart in FIG. 8, the switch SW for the downward spray nozzle NB includes a pulse generating mechanism SW1 and a switch body SW2. The pulse generating mechanism SW1 generates pulses at an interval from one of the die holes 41 being located right below the downward spray nozzle NB to the following adjacent die hole 41 being located therebelow. The switch body SW2 distributes power to the charging device CD only while a pulse is outputted from the pulse generating mechanism SW1.

The pulse generating mechanism SW1 has a circular disk SW11, a sensor SW13, and a pulse generator element SW14. The circular disk SW11 is rotated at a cycle identical to that of the turret 3 and has at a constant pitch projections SW12 of the number identical to the number of pairs of the upper punches 5 and the lower punches 6. The sensor SW13 senses the approaching projection SW12 provided on the circular disk SW11 and generates a projection sensing signal. The pulse generator element SW14 receives the projection sensing signal from the sensor SW13 and generates a pulse.

The switch body SW2 has a pulse receiver element SW21 and a switcher element SW22. The pulse receiver element SW21 receives pulses generated by the pulse generator element SW14. The switcher element SW22 turns on the power to the charging device CD when the pulse receiver element SW21 receives a pulse, and otherwise turns off the power to the charging device CD.

The pulse is oscillated during a time period T0 from one of the die holes 41 starting to pass by right below the downward spray nozzle NB to the die hole 41 completing to pass thereby. The time length from the powder lubricant L being ejected to the powder lubricant L reaching each of the die holes 41 is short enough to be ignored.

Though not illustrated in the drawings, the switch SW connected to the charging device CD for the upward spray nozzle NU has a configuration similar to the above, except that the pulse is oscillated during a time period from the lower end of one of the upper punches 5 starting to pass by right above the upward spray nozzle NU to the lower end of the upper punch 5 completing to pass thereby, instead of the time period T0 from one of the die holes 41 starting to pass by right below the downward spray nozzle NB to the die hole 41 completing to pass thereby.

In the configuration described above, when the powder lubricant spray device LS is powered on to spray a powder lubricant L, the electrode ED for the downward spray nozzle NB has a negative high potential with respect to the upper punches 5, the lower punches 6, and the dies 4 as well as the turret 3 during a time period from one of the die holes 41 starting to pass by right below the downward spray nozzle NB to the die hole 41 completing to pass thereby. In this case, the powder lubricant L sprayed from the downward spray nozzle NB is negatively electrostatically charged. On the other hand, the electrode ED for the upward spray nozzle NU has a negative high potential with respect to the upper punches 5, the lower punches 6, and the dies 4 as well as the turret 3 during a time period from the lower end of one of the upper punches 5 starting to pass by right below the upward spray nozzle NU to the lower end of the upper punch 5 completing to pass thereby. In this case, the powder lubricant L sprayed from the upward spray nozzle NU is negatively electrostatically charged. However, the powder lubricant L is electrostatically uncharged except the above time periods. The pulses are oscillated at an interval of a predetermined time period T1 obtained by dividing a reciprocal of the rotation number of the turret 3 by the number of the dies 4.

The upper punches 5, the lower punches 6, and the dies 4, toward which the powder lubricant L is sprayed, are grounded due to the grounded turret 3. Thus, the upper punches 5, the lower punches 6, and the dies 4 each have a potential higher than that of the powder lubricant L electrostatically charged by the charging devices CD. When sprayed toward the upper punches 5, the lower punches 6, and the dies 4, the negatively electrostatically charged powder lubricant L is attracted to the upper punches 5, the lower punches 6, and the dies 4 due to electrostatic forces, and electrostatically adheres to the target surfaces, namely, the lower end surfaces 5a of the upper punches 5, the upper end surfaces 6a of the lower punches 6, and the inner peripheral surfaces of the die holes 41 in the dies 4. Once adhering to the target regions of the upper punches 5, the lower punches 6, and the dies 4, the powder lubricant L remains electrostatically attracted thereto and is not separated therefrom. The electrostatically uncharged powder lubricant L is directed to the dust pickup conduit P due to the dust pickup airflow provided by the powder lubricant retrieving mechanism and is retrieved into the dust pickup device LS5.

Thus, upon adoption of the configuration according to the present embodiment, the powder lubricant L reaching the lower end surfaces 5a of the upper punches 5, the upper end surfaces 6a of the lower punches 6, and the die holes 41 in the dies 4 is electrostatically charged, while the powder lubricant L reaching regions other than the above is not electrostatically charged. The powder lubricant L reaching the lower end surfaces 5a of the upper punches 5, the upper end surfaces 6a of the lower punches 6, and the inner peripheral surfaces of the die holes 41 in the dies 4 is electrostatically attracted thereto against the dust pickup airflow provided by the powder lubricant retrieving mechanism. On the other hand, the remaining powder lubricant L is guided to the dust pickup conduit P by the dust pickup airflow of the powder lubricant retrieving mechanism. The powder lubricant L guided to the dust pickup conduit P is retrieved into the dust pickup device LS5. Therefore, the powder lubricant L is allowed to securely adhere to the lower end surfaces 5a of the upper punches 5, the upper end surfaces 6a of the lower punches 6, and the die holes 41 in the dies 4, while contamination being suppressed.

The switch SW connected to the charging device CD for the downward spray nozzle NB has the pulse generating mechanism SW1 that generates pulses at the interval from one of the die holes 41 being located right below the downward spray nozzle NB to the following adjacent die hole 41 being located right below the downward spray nozzle NB, and the switch body SW2 that distributes power to the charging device CD only while a pulse is outputted from the pulse generating mechanism SW1. Accordingly, it is possible to easily realize the switch SW that distributes power to the charging device CD only while the die holes 41 are located right below the downward spray nozzle NB.

Similarly, the switch SW connected to the charging device CD for the upward spray nozzle NU has the pulse generating mechanism SW1 that generates pulses at the interval from the lower end of one of the upper punches 5 being located right above the upward spray nozzle NU to the lower end of the following adjacent upper punch 5 being located right above the upward spray nozzle NU, and the switch body SW2 that distributes power to the charging device CD only while a pulse is outputted from the pulse generating mechanism SW1. Accordingly, it is possible to easily realize the switch SW that distributes power to the charging device CD only while the lower ends of the upper punches 5 are located right above the upward spray nozzle NU.

It should be noted that the present invention is not limited to the embodiment described above.

In the above embodiment, the powder lubricant is sprayed continuously from the downward spray nozzle as well as from the upward spray nozzle. Alternatively, the powder lubricant may be periodically sprayed. More specifically, in such a mode, the powder lubricant is sprayed from the downward spray nozzle during a time period corresponding to a timing of the powder lubricant sprayed from the downward spray nozzle reaching one of the die holes, while the powder lubricant is sprayed from the upward spray nozzle during a time period corresponding to a timing of the powder lubricant sprayed from the upward spray nozzle reaching the lower end of each of the upper punches.

The embodiment described above adopts the pulse generating mechanism including the circular disk that is rotated at the cycle identical to that of the turret and has at the constant pitch the projections of the number identical to the number of pairs of the upper punches and the lower punches, the sensor that senses the approaching projection provided on the circular disk and generates a projection sensing signal, and the pulse generator element that receives the projection sensing signal from the sensor and generates a pulse. The pulse generating mechanism may be alternatively provided with a pulse generator element that generates pulses at an interval preliminarily calculated in accordance with the rotation number of the turret as well as the number of pairs of the upper punches and the lower punches, and a pulse timing adjuster element that adjusts start times for generating the pulses by the pulse generator element. Further alternatively, there may be employed a rotary encoder that is connected to the rotary shaft of the turret.

Furthermore, there may be adopted switching means, in place of the pulse generating mechanism, the switching means being connected to a timer including a timer body that repeatedly switches on and off at an interval preliminarily calculated in accordance with the rotation number of the turret as well as the number of pairs of the upper punches and the lower punches, and a timing adjuster element that adjusts times for switching on and off the timer.

In the embodiment above described, the separate switching means are connected respectively to the charging device that is connected to the downward spray nozzle and the charging device that is connected to the upward spray nozzle. Alternatively, only one switching means may be connected only to the charging device that is connected to the downward spray nozzle.

The present invention may be modified in various ways within a range not departing from the purposes thereof.

What is claimed is:

1. A powder compression molding machine comprising:
upper punches and lower punches disposed to face with each other along one central axis;
die holes allowing tips of the upper punches and the lower punches to be respectively inserted thereinto, the upper punches and the lower punches being shifted to approach each other with the tips thereof being inserted in the corresponding die holes, so that a powder material filled in the die holes is compressed and molded; and
powder lubricant spraying means for spraying a powder lubricant toward the die holes before the powder material is filled therein, wherein
the powder lubricant spraying means includes:
a downward spray nozzle that sprays the powder lubricant toward the die holes;
a powder lubricant retrieving mechanism that retrieves a superfluous powder lubricant out of the powder lubricant sprayed from the powder lubricant spraying means;
a charging device that electrostatically charges the powder lubricant sprayed from the downward spray nozzle; and
switching means that is connected to the charging device and switches to allow only the powder lubricant sprayed at a timing of reaching each of the die holes to be electrostatically charged.

2. The powder compression molding machine according to claim 1, wherein the switching means has:
a pulse generating mechanism that generates pulses at an interval from one of the die holes being located right below the downward spray nozzle to the following adjacent die hole being located therebelow; and
a switch body that distributes power to the charging device only while each of the pulses is outputted from the pulse generating mechanism.

3. The powder compression molding machine according to claim 1, wherein the powder lubricant spraying means further includes:
an upward spray nozzle that sprays the powder lubricant toward lower ends of the upper punches;
an airflow supplying mechanism that blows air toward the powder lubricant retrieving mechanism so as to inhibit scattering of the powder lubricant sprayed from the upward spray nozzle;
a second charging device that electrostatically charges the powder lubricant sprayed from the upward spray nozzle; and
second switching means that is connected to the second charging device and switches to allow only the powder lubricant sprayed at a timing of reaching the lower end of each of the upper punches to be electrostatically charged.

4. The powder compression molding machine according to claim 2, wherein the powder lubricant spraying means further includes:
an upward spray nozzle that sprays the powder lubricant toward lower ends of the upper punches;
an airflow supplying mechanism that blows air toward the powder lubricant retrieving mechanism so as to inhibit scattering of the powder lubricant sprayed from the upward spray nozzle;
a second charging device that electrostatically charges the powder lubricant sprayed from the upward spray nozzle; and
second switching means that is connected to the second charging device and switches to allow only the powder lubricant sprayed at a timing of reaching the lower end of each of the upper punches to be electrostatically charged.
